(19) United States
(12) Patent Application Publication
(10) Pub. No.: US 2018/0144158 A1
(43) Pub. Date: May 24, 2018

(54) ELECTRONIC DEVICE AND SETTING METHOD

(71) Applicants: Inventec (Pudong) Technology Corporation, Shanghai (CN); INVENTEC CORPORATION, Taipei City (TW)

(72) Inventors: Ming-Yuan LIU, TAIPEI CITY (TW); Chian-Ting CHEN, TAIPEI CITY (TW); Huan-Chung HSU, TAIPEI CITY (TW); An-Chi CHENG, TAIPEI CITY (TW); Chao-Chieh CHEN, TAIPEI CITY (TW); Yu-Jeng YANG, TAIPEI CITY (TW)

(21) Appl. No.: 15/473,634

(22) Filed: Mar. 30, 2017

(30) Foreign Application Priority Data
Nov. 21, 2016 (CN) 201611043745.1

(51) Int. Cl. G06F 21/78; G06F 9/445

(52) U.S. Cl. CPC G06F 21/78; G06F 8/61

(57) ABSTRACT

An electronic device includes a first connecting terminal, a second connecting terminal, a first memory, and a first processor. The first connecting terminal is configured to be inserted into a computer host. The second connecting terminal is configured to be inserted by a storing device. The first memory is configured to store a first software module. The first processor is coupled to the first memory. The first processor is configured to execute the first software module, to divide a second memory of the storing device into a public area and a private area through the second connecting terminal.

### RELATED APPLICATIONS

This application claims priority to Chinese Application Serial Number 201611043745.1, filed Nov. 21, 2016, which is herein incorporated by reference.

### BACKGROUND

### Technical Field

The present disclosure relates to an electronic technology. More particularly, the present disclosure relates to an electronic device and a setting method.

### Description of Related Art

With the development of technology, various storing devices are utilized to store data. The storing devices are, for example, Universal Serial Bus (USB) devices or Solid State Disk (SSD) devices. However, when a user takes one of the storing devices, the user could read data in the storing device or write data into the storing device. In other words, the privacy of the storing device is very low.

Therefore, a heretofore-unaddressed need exists to address the aforementioned deficiencies and inadequacies.

### SUMMARY

One embodiment of the present disclosure is related to an electronic device. The electronic device includes a first connecting terminal, a second connecting terminal, a first memory, and a first processor. The first connecting terminal is configured to be inserted into a computer host. The second connecting terminal is configured to be inserted by a storing device. The first memory is configured to store a first software module. The first processor is coupled to the first memory. The first processor is configured to execute the first software module, to divide a second memory of the storing device into a public area and a private area through the second connecting terminal.

Another embodiment of the present disclosure is related to a setting method. The setting method includes: determining whether a storing device is inserted into a connecting terminal of an electronic device or not; when it is determined that the electronic device is inserted by the storing device, executing a first software module in the electronic device by a processor of the electronic device, such that a memory of the storing device is divided into a public area and a private area; and when it is determined that the electronic device is not inserted by the storing device, sending out a notification message by the processor.

As the above embodiments, the electronic device and the setting method of this disclosure, the public area and the private area of various storing devices are able to be set through an easy manner, and then the privacies of the storing devices are increased.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a computer host, an electronic device, and a storing device according to some embodiments of the present disclosure;

FIG. 2 is a schematic diagram illustrating an electronic device, an extension device, and a storing device according to some embodiments of this disclosure; and

FIG. 3 is a flow diagram illustrating a setting method according to some embodiments of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

Moreover, the drawings are for the purpose of illustration only, and are not in accordance with the size of the original drawing. The components in description are described with the same number to understand.

Moreover, unless otherwise defined, all terms used in this specification and claims generally have their ordinary meaning in the art, within the context of the disclosure, and in the specific context where each term is used. Certain terms that are used to describe the disclosure are discussed below, or elsewhere in the specification, to provide additional guidance to the practitioner regarding the description of the disclosure.

As used herein with respect to the “first”, “second” . . . is not special order or pick the alleged meaning, but simply to distinguish the operation described in the same terms or elements of it.

The terms “comprises”, “comprising”, “includes”, “including”, “has”, “having” . . . etc. used in this specification are open-ended and their meaning are “comprises but not limited”.

As used herein, “coupled” or “connected” may refer to two or more elements are in direct physical or electrical contact made, or indirectly, as a mutual entity or electrical contact, and “coupled ”or“ connected ”may also refer to two or more elements are operating or action.

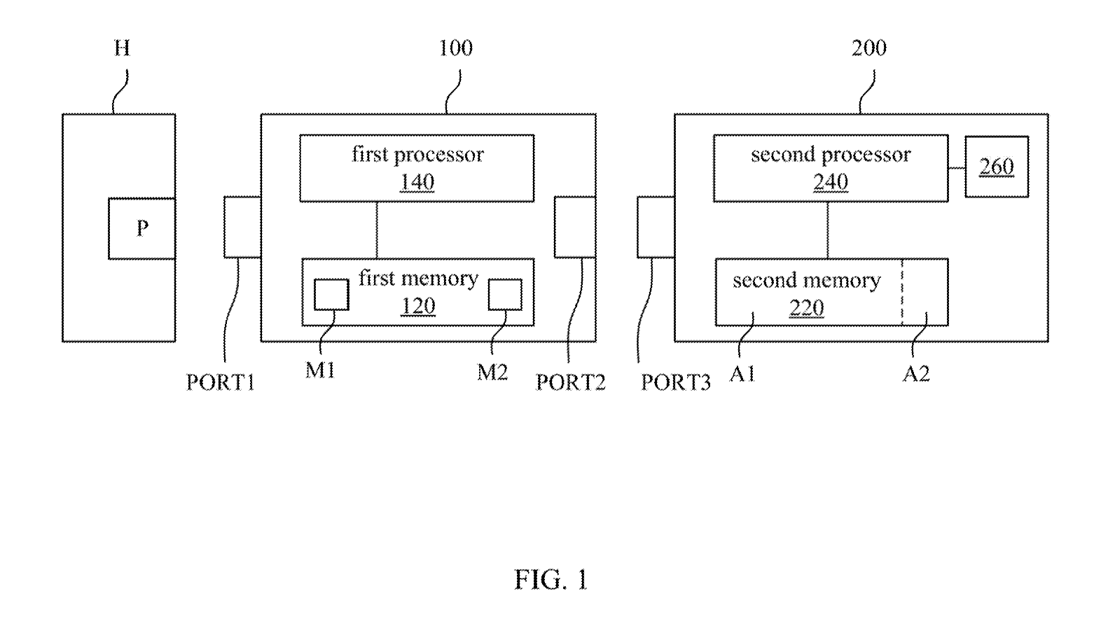

Reference is now made to FIG. 1. FIG. 1 is a schematic diagram illustrating a computer host H, an electronic device 100, and a storing device 200 according to some embodiments of the present disclosure. As illustratively shown in FIG. 1, the computer host H is, for example, a host of a computer system. The computer host H includes a connecting terminal P. In some embodiments, the connecting terminal P is, for example, a Universal Serial Bus (USB) port, and the electronic device 100 is, for example, an USB device, but is not limited thereto. By the configurations, the electronic device 100 is able to be inserted into the connecting terminal P of the computer host H.

As illustratively shown in FIG. 1, the electronic device 100 includes a first connecting terminal PORT1 and a second connecting terminal PORT2. In some embodiments, the first connecting terminal PORT1 is disposed correspondingly to the second connecting terminal PORT2. For example, the first connecting terminal PORT1 is disposed at a front end of the electronic device 100, and the second connecting terminal PORT2 is disposed at a back end of the electronic device 100. In some embodiments, a type of the first connecting terminal PORT1 is different from a type of the second connecting terminal PORT2. For example, the first connecting terminal PORT1 is a male connector, and the second connecting terminal PORT2 is a female connector. In some embodiments, the first connecting terminal PORT1 is configured to be inserted into the connecting terminal P of the computer host H. Thus, a user may operate the computer to perform a read operation or a write operation on data in the electronic device 100.

The second connecting terminal PORT2 is configured to be inserted by the storing device 200. In some embodiments, the storing device 200 is another USB device, but is not limited thereto. In some other embodiments, the storing device 200 is, for example, a solid state disk (SSD) or other various storing devices. In some embodiments, a storing capacity of the storing device 200 is larger than a storing capacity of the electronic device 100. As illustratively shown in FIG. 1, the storing device 200 includes a third connecting terminal PORT3. The third connecting terminal PORT3 may be disposed at a front end of the storing device 200. In some embodiments, a type of the third connecting terminal PORT3 is different from the type of the second connecting terminal PORT2. For example, the second connecting terminal PORT2 is the female connector, and the third connecting terminal PORT3 is a male connector. Accordingly, the third connecting terminal PORT3 is able to be inserted into the second connecting terminal PORT2, such that the storing device 200 is electrically connected to the electronic device 100.

In operation, the computer host H, the electronic device 100, and the storing device 200 are connected in series. Thus, the user may operate the computer to set the storing device 200 through the electronic device 100. The operations in detail will be described in following paragraphs.

As illustratively shown in FIG. 1, the electronic device 100 further includes a first memory 120 and a first processor 140. The first processor 140 is coupled to the first memory 120. As illustratively shown in FIG. 1, the storing device 200 further includes a second memory 220 and a second processor 240. The second processor 240 is coupled to the second memory 220.

In some embodiments, the first memory 120 and the second memory 220 are, for example, flash memories. The first processor 140 and the second processor 240 are, for example, CPUs, processing chips, or other various hardware elements (such as, processing circuits) having processing and controlling functions.

The first memory 120 is configured to store a first software module M1. In some embodiments, the first software module M1 is implemented as a computer program code. Except for the first software module M1, the first memory 120 is also configured to store other data. The first processor 140 is configured to execute the first software module M1, to divide the second memory 220 of the storing device 200 into a public area A1 and a private area A2 through the second connecting terminal PORT2 and the third connecting terminal PORT3. Data stored in the public area A1 is able to be directly accessed by the user, but data stored in the private area A2 is unable to be directly accessed by the user.

In some embodiments, the first processor 140 is configured to execute the first software module M1, to assign a storing capacity corresponding to the public area A1 and a storing capacity corresponding to the private area A2. For example, it is assigned that the storing capacity of the public area A1 is larger than the storing capacity of the private area A2. In some other embodiments, it is assigned that the storing capacity of the public area A1 is smaller than the storing capacity of the private area A2. In some other embodiments, it is assigned that the storing capacity of the public area A1 is equal to the storing capacity of the private area A2. Briefly, for different applications, the storing capacity of the public area A1 and the storing capacity of the private area A2 may be properly adjusted according to practical needs.

In some embodiments, the first processor 140 is configured to execute the first software module M1, such that a security code corresponding to the private area A2 is generated. In some embodiments, the security code is transmitted to and stored in a code storing unit 260. In some embodiments, the code storing unit 260 is a register. In some other embodiments, the code storing unit 260 is disposed in the second memory 220. When the security code is set, if a user wants to access the data in the private area A2, the user needs to key in the security code.

After the public area A1 and the private area A2 are assigned and the security code is set, the storing device 200 may be pulled out of the electronic device 100. Then, the storing device 200 may be inserted into the computer host H. The user may perform an accessing operation on the data in the storing device 200 by operating the computer.

In some embodiments, the first memory 120 is configured to store a second software module M2. In some embodiments, the second software module M2 is also implemented as a computer program code. The first processor 140 executes the first software module M1, to install the second software module M2 into the storing device 200 through the second connecting terminal PORT2. When the second software module M2 is installed in the storing device 200, the second software module M2 is able to be executed by the second processor 240. In detail, the second processor 240 executes the second software module M2, to compare a code inputted by the user with the aforementioned security code. If the second processor 240 determines that the code inputted by the user is matched with the aforementioned security code, the user is allowed to access the data stored in the private area A2. If the second processor 240 determines that the code inputted by the user is not matched with the aforementioned security code, the user is rejected to access the data stored in the private area A2.

The configurations of the electronic device 100 and the storing device 200 are given for illustrative purposes only. Various configurations of the electronic device 100 and the storing device 200 are within the contemplated scope of the present disclosure.

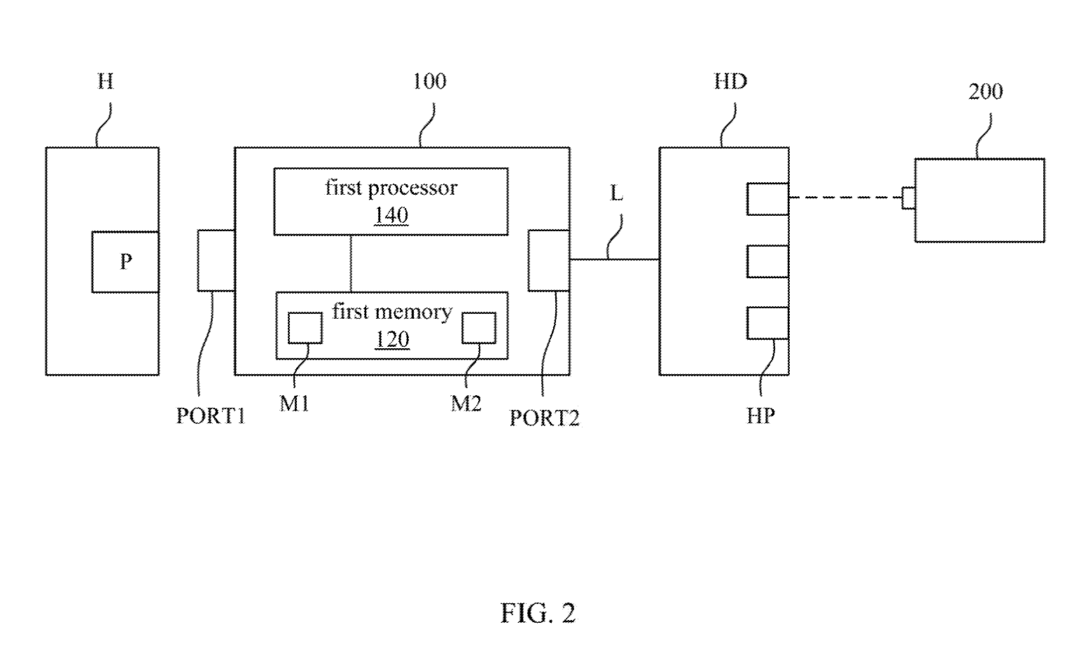

Reference is now made to FIG. 2. FIG. 2 is a schematic diagram illustrating the electronic device 100, an extension device HD, and the storing devices 200 according to some embodiments of this disclosure. For ease of understanding, with respect to the embodiments of FIG. 1, like elements in FIG. 2 are designated with the same reference numbers. In some embodiments, the operations of the storing devices 200 in FIG. 2 are similar to the storing device 200 in FIG. 1, so not described herein again.

In some embodiments, the second connecting terminal PORT2 is configured to be inserted by the extension device HD. In some embodiments, the extension device HD is a hub. In some embodiments, the extension device HD is electrically connected to the electronic device 100 through a transmission line L. The extension device HD includes a plurality of extension terminal HP. The extension ports HP are configured to be inserted by a plurality of storing devices 200. For simplicity, only one storing device 200 is depicted. By this configuration, the user may operate the computer host H, to set the plurality of storing devices 200 through the electronic device 100 and the extension device HD. Thus, the extension ability may be increased.

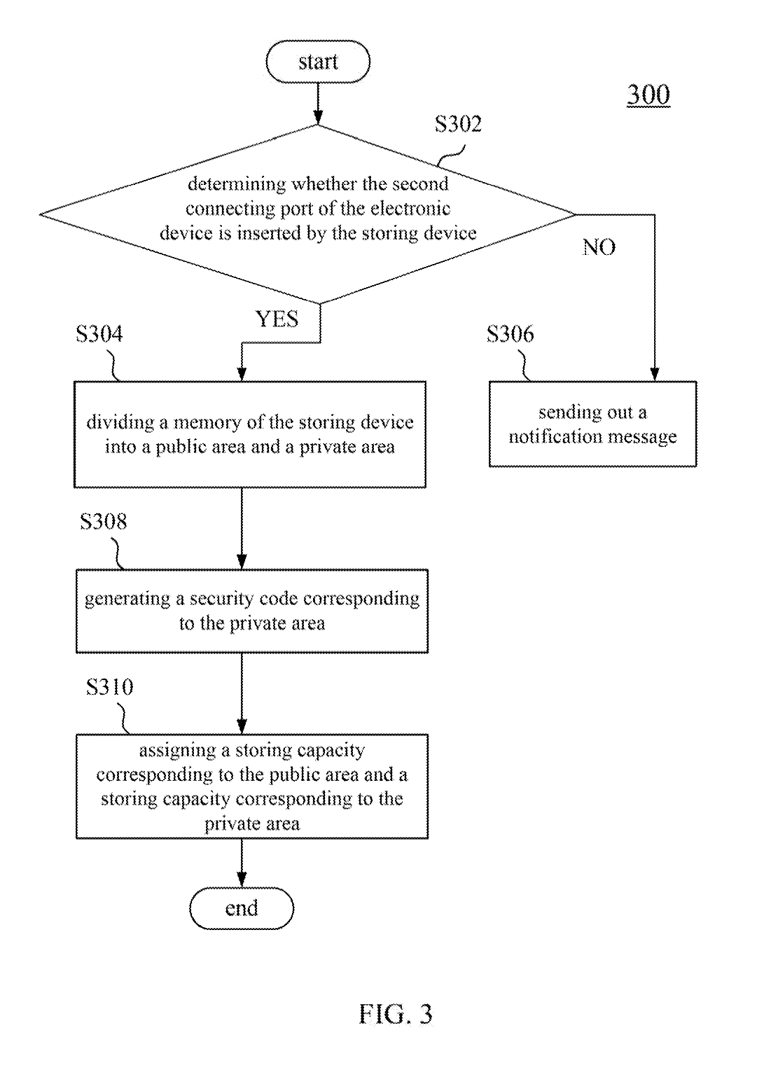

Reference is now made to FIG. 3. FIG. 3 is a flow diagram illustrating a setting method 300 according to some embodiments of this disclosure. In some embodiments, the setting method 300 is implemented to the devices in FIG. 1. For better understanding of the present disclosure, the setting method 300 is discussed in relation to the devices shown in FIG. 1, but is not limited thereto.

Step S302 is for determining whether the second connecting terminal PORT2 of the electronic device 100 is inserted by the storing device 200 or not.

In step S304, when it is determined that the second connecting terminal PORT2 of the electronic device 100 is inserted by the storing device 200, the processor 140 of the electronic device executes the software module in the electronic device 100, such that the memory 220 of the storing device 200 is divided into the public area A1 and the private area A2.

In step S306, when it is determined that the second connecting terminal PORT2 of the electronic device 100 is not inserted by the storing device 200, the processor 140 sends out a notification message, to notify the user. In some embodiments, the notification message is implemented as a pop-up window, but is not limited thereto.

In some embodiments, the setting method 300 further includes step S308 and step S310.

In step S308, the first processor 140 of the electronic device 100 executes the first software module M1, to generate the security code corresponding to the private area A2.

In step S310, the first processor 140 of the electronic device 100 executes the first software module M1, to assign the storing capacity corresponding to the public area A1 and the storing capacity corresponding to the private area A2.

The above description of the setting method 300 includes exemplary operations, but the operations of the setting method 300 are not necessarily performed in the order described. The order of the operations of the setting method 300 disclosed in the present disclosure are able to be changed, or the operations are able to be executed simultaneously or partially simultaneously as appropriate, in accordance with the spirit and scope of various embodiments of the present disclosure.

As the above embodiments, the electronic device and the setting method of this disclosure, the public area and the private area of various storing devices are able to be set through an easy manner, and then the privacies of the storing devices are increased.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electronic device, comprising:
a first connecting terminal configured to be inserted into a computer host;
a second connecting terminal configured to be inserted by a storing device;
a first memory configured to store a first software module; and
a first processor coupled to the first memory, wherein the first processor is configured to execute the first software module, to divide a second memory of the storing device into a public area and a private area through the second connecting terminal.

2. The electronic device of claim 1, wherein the first processor is configured to execute the first software module, such that a security code corresponding to the private area is generated.

3. The electronic device of claim 2, wherein the first memory is further configured to store a second software module, and the first processor is configured to execute the first software module, to install the second software module into the storing device through the second connecting terminal.

4. The electronic device of claim 3, wherein the second software module is configured to be executed by a second processor of the storing device, to determine whether the security code is matched or not.

5. The electronic device of claim 3, wherein the second connecting terminal is configured to be connected to a third connecting terminal of the storing device.

6. The electronic device of claim 5, wherein the second connecting terminal is a female connector, and the third connecting terminal is a male connector.

7. The electronic device of claim 1, wherein the first connecting terminal is a male connector.

8. The electronic device of claim 1, wherein the first connecting terminal and the second connecting terminal are disposed at two ends of the electronic device respectively.

9. The electronic device of claim 1, wherein the electronic device is a universal serial bus device.

10. The electronic device of claim 1, wherein the first processor is configured to execute the first software module, to assign a plurality of storing capacities corresponding to the public area and the private area respectively.

11. The electronic device of claim 10, wherein the first processor is configured to execute the first software module, to assign a first storing capacity of the storing capacities corresponding to the public area to be different from a second capacity of the storing capacities corresponding to the private area.

12. The electronic device of claim 1, wherein the second connecting terminal is configured to be inserted by an extension device through a transmission line, the extension device comprises a plurality of extension ports, and the plurality of extension ports are configured to be inserted by a plurality of storing devices.

13. The electronic device of claim 12, wherein the extension device is a hub.

14. The electronic device of claim 1, wherein a first storing capacity of the second memory is larger than a second storing capacity of the first memory.

15. A setting method, comprising:
determining whether a storing device is inserted into a connecting terminal of an electronic device or not;
when it is determined that the electronic device is inserted by the storing device, executing a first software module in the electronic device by a processor of the electronic device, such that a memory of the storing device is divided into a public area and a private area; and
when it is determined that the electronic device is not inserted by the storing device, sending out a notification message by the processor.

16. The setting method of claim 15, further comprising:
executing the first software module by the processor, to generate a security code corresponding to the private area.

17. The setting method of claim 16, further comprising:
executing the first software module by the processor, to install a second software module into the storing device, such that the storing device is configured to determine a received code is matched with the security code or not.

18. The setting method of claim 15, further comprising:
executing the first software module by the processor, to assign a plurality of storing capacities corresponding to the public area and the private area respectively.

19. The setting method of claim 15, further comprising:
executing the first software module by the processor, to assign a first storing capacity of the public area is different from a second storing capacity of the private area.
